(19) United States
(12) Patent Application Publication
(10) Pub. No.: US 2026/0022258 A1
(43) Pub. Date: Jan. 22, 2026

(54) CONDUCTIVE COATING COMPRISING COPPER SULFIDE/POLYPYRROLE AND PROCESS OF PRODUCING THE SAME THEREFROM

(71) Applicants: Meng Ouyang, OAKLEY, CA (US); Li Yi, OAKLEY, CA (US)

(72) Inventors: Meng Ouyang, OAKLEY, CA (US); Li Yi, OAKLEY, CA (US)

(21) Appl. No.: 18/778,789

(22) Filed: Jul. 19, 2024

(51) Int. Cl. C09D 5/24; C09D 7/62; C09D 165/00; D06M 11/51; D06M 15/356; D06M 101/32

(52) U.S. Cl. CPC C09D 5/24; C09D 7/62; C09D 165/00; D06M 11/51; D06M 15/3562; D06M 2101/32; D06M 2200/00

(57) ABSTRACT

Many non-conductive engineered materials, including organic or inorganic powders, fibers, films, foams and even bulk materials, are used as substrates and effectively coated with a thin layer of polypyrrole (PPy) by the so-called “in-situ polymerization” of pyrrole monomer. Subsequently, a layer of conductive copper sulfide (CuS) as a top coat is applied to the above PPy-coated substrates by the electroless plating so as to render them electrically conductive on their surfaces. It is critical and useful that PPy is able to facilitate the electroless plating of CuS on its surface with enhanced adhesion, which results in a CuS/PPy coating system having stable electrical conductivity even under the condition of a high temperature (up to ˜200° C.) for a prolonged time.

### FIELD OF THE INVENTION

The present invention relates to a conductive coating comprising copper sulfide/polypyrrole and process of producing the same therefrom. Particularly, the invention of this coating process renders many non-conductive engineered materials (including organic or inorganic powders, fibers, films, foams and even bulk materials) electrically conductive on their surfaces.

### Background of the Invention

Many non conductive engineered materials, including organic or inorganic powders, fibers, films, foams and even bulk materials, can be imparted with the desired properties of electrostatic discharge, electromagnetic shielding, microwave absorption, etc. by rendering them electrically conductive only on their surfaces. This technical approach is very important, and has been extensively applied to industrial practice. In the past decades, some intrinsically conductive polymers like polypyrrole (PPy), polyaniline and polythiophene have been studied and developed as conductive top coatings on the non-conductive substrate surfaces. Many non-conductive engineered materials, including organic or inorganic powders, fibers, films, foams and even bulk materials, can be effectively coated with a thin layer of conductive PPy by the so-called “in-situ polymerization” of pyrrole monomer in order to render their surfaces conductive.

Another technical approach is to render the conventional thermoplastic or thermosetting polymers electrically conductive by an addition of conductive powders such as powdery metals, carbon materials, etc. To exploit new conductive materials, various PPy-coated powders, such as silica, titanium dioxide, mica, clay, poly(vinyl chloride), polyethylene, nylon, etc. have been produced using the facile process of “in-situ polymerization”. These PPy-coated powders, which are useful as conductive additives, can be compounded with non-conductive polymers to generate the conductive polymeric composites having an advantage of cost-efficiency as compared with other conductive additives like powdery metals or carbon materials.

It was reported that poly(vinyl chloride) powder with an average particle size of 100 μm was coated with a thin layer of conductive PPy by the “in-situ polymerization” of pyrrole monomer. The procedure involves chemically polymerizing pyrrole in the present of the poly(vinyl chloride) powder dispersed in an aqueous solution of ferric chloride. It was found that about 1 wt % pyrrole monomer was needed to effectively encapsulate overall particles of poly(vinyl chloride) powder. The PPy-coated poly(vinyl chloride) powder demonstrated the resistivity of about 100 Ω·cm. However, the poor thermal stability and durability of the PPy coating limited the practical applications of this powder [Electrical and Mechanical Properties of Pre-localized Polypyrrole/Poly(vinyl chloride) Conductive Composites, Polymer Engineering & Science, Vol. 36, No. 21, p. 2676 (1996)]. In fact, it is still a big challenge so far for PPy-based coating materials to have enough thermal stability and durability with respect to the electrical conductivity in the aspect of many applications.

It is well known that bio-based (natural) materials are proper substitutes for petroleum-based materials in order to achieve sustainability of the resources as well as minimizing carbon dioxide emission. As one of the most important bio-based polymer materials, starch can be agriculturally produced at low cost, and has been used extensively as a raw material in polymer industry. Starch is biodegradable and environmentally friendly. Since it is naturally in powdery form, starch can be feasibly incorporated as an additive or filler into the conventional thermoplastic or thermosetting polymers for biodegradability or other functional reasons. It is also possible to develop starch-based conductive powders by coating starch particles with a thin layer of electrically conductive materials, which will be useful as a newer type of conductive additives for polymer materials having advantages of cost-efficiency and biodegradability.

On the other hand, it is known that a conductive coating can also be formed on a substrate by electroless plating of copper sulfide (CuS, an inorganic semiconductor) which is usually far superior to a PPy coating in thermal stability and durability with respect to the electrical conductivity. However, adhesion of the CUS coating to the substrate surface primarily depends on some particular chemical moieties on the surface of the substrate. So far it has been known that those chemical moieties containing nitrile (—CN) or amine (—NR₂, R═H, C) are effective. However, in most cases, the nitrilation or amination of the substrate surface is a challenge due to the complex processing, high risk of pollution or high cost. For example, the nitrilation or amination of the surface of starch particles currently might not be engineerable at a reasonable cost.

### SUMMARY OF THE INVENTION

In accordance with the present invention there is provided, many non-conductive engineered materials, including organic or inorganic powders, fibers, films, foams and even bulk materials, are used as substrates and effectively coated with a thin layer of polypyrrole (PPy) by the so-called “in-situ polymerization” of pyrrole monomer. Subsequently, a layer of conductive copper sulfide (CuS) as a top coat is applied to the above PPy-coated substrates by the electroless plating so as to render them electrically conductive on their surfaces. It is critical and useful that PPy is able to facilitate the electroless plating of CuS on its surface with enhanced adhesion, which results in a CuS/PPy coating system having stable electrical conductivity even under the condition of a high temperature (up to ˜200° C.) for a prolonged time.

### DETAILED DESCRIPTION OF THE INVENTION

In accordance with the present invention there is provided, many non-conductive engineered materials, including organic or inorganic powders, fibers, films, foams and even bulk materials, are used as substrates and effectively coated with a thin layer of polypyrrole (PPy) by the so-called “in-situ polymerization” of pyrrole monomer. The procedure usually involves chemically oxidational polymerizing pyrrole monomer that is added dropwise to an aqueous solution of oxidants, e.g., ferric chloride, in the present of a substrate material immersed or dispersed in the reaction solution. It is found that 0.01 to 20 wt % pyrrole monomer is needed to effectively encapsulate overall the substrate. Subsequently, a layer of conductive copper sulfide (CaS) as a top coat is applied to the above PPy-coated substrates by the electroless plating so as to render them electrically conductive on their surfaces. This processing involves immersing or dispersing the above PPy-coated substrates in an aqueous solution comprising copper (II) salts, e.g., copper sulfate, and sulfur-containing reducing agents, e.g., sodium thiosulfate, with an adequate concentration for all reaction agents. The so-called electroless plating of CuS on the substrate surface usually takes place when the reaction is run at 40 to 100° C. for 1 to 10 hours. It is critical and useful that PPy coating is able to facilitate the electroless plating of CuS on its surface with enhanced adhesion, which results in a CuS/PPy coating system having stable electrical conductivity even under the condition of a high temperature (up to ˜200° C.) for a prolonged time.

The present invention indicates that PPy has similarity to the nitrile group-containing (—CN) polymers in the effectiveness that facilitates the electroless plating of copper sulfide on its surface with enhanced adhesion. The conductivity of PPy is not necessary if it is applied to a substrate surface just to mediate forming the copper sulfide coating in the process of the electroless plating. The PPy mediated substrates can be organic or inorganic powders, fibers, films, foams and even bulk materials.

An exemplary aspect of the present invention relates to a starch-based conductive powder by coating starch particles with a thin layer of electrically conductive materials. Initially we tried to coat starch powder with PPy using the same process of the “in-situ polymerization” as the above-mentioned, and noticed that starch particles can be facilely and effectively coated with PPy. Subsequently, a layer of conductive copper sulfide (CuS) as a top coat was applied to the above PPy-coated starch by the electroless plating process. It was noticed that the resulting CuS/PPy coated starch showed desired thermal stability and durability with respect to its electrical conductivity. In order to verify the mediating effect of PPy, we tried to treat starch powder directly with the electroless plating of CuS, and found that there was no CuS coating formed on the starch particles. It is not surprising at all that electroless plating of CuS failed to coat starch powder in the absence of nitrilation or amination of the starch particle surface.

Another exemplary aspect of the present invention relates to a polyethylene terephthalate (PET)-based conductive fabric by coating a PET fabric with a thin layer of electrically conductive materials. We tried first to coat the PET fabric with PPy using the same process of the “in-situ polymerization” as the above-mentioned, and found that the PET fabric can be facilely and effectively coated with PPy. As expected, this PPy-coated fabric was electrically conductive although the content of pyrrole monomer was less than 5 wt %, which render the surface of the PET fabric electrically conductive. However, this PPy-coated fabric was not thermally stable, i.e., its conductivity would decay obviously if it was heated at 200° C. for 2 hours. Subsequently, a layer of conductive copper sulfide (CuS) as a top coat was applied to the above PPy-coated fabric by the electroless plating process. It was noticed that the resulting CuS/PPy coated fabric showed desired thermal stability and durability with respect to its electrical conductivity. In order to confirm the mediating effect of PPy, we also tried to treat PET fabrics directly with the electroless plating of CuS, and found that there was no CuS coating formed on the fabric surface. It is not surprising at all that electroless plating of CuS failed to coat the PET fabrics in the absence of nitrilation or amination of the fabric surface.

In the present invention, a process of the conductive coatings of copper sulfide/polypyrrole is typically as follows:
1. An oxidant, such as ferric chloride, persulfate, cerium ammonium nitrate, etc., is dissolved in water at a concentration of 0.1 to 20 wt % for later use.
2. A substrate material to be treated, including organic or inorganic powders, fibers, films, foams and even bulk materials, is dispersed or immersed in the above oxidant aqueous solution, stirring at a temperature of 0 to 45° C.
3. Pyrrole monomer or pyrrole solution in a solvent like alcohols is added dropwise to the above reaction system, stirring for 30 minutes to 2 hours at a temperature of 0 to 45° C. to complete the “in-situ polymerization” reaction. The resulting product is filtered and washed with sufficient water.
4. Copper sulfate is dissolved in water at a concentration of 1 to 30 wt % for later use.
5. The product from step 3, i.e., the PPy-coated substrate, is dispersed or immersed in the above copper sulfate aqueous solution.
6. 1 to 20 wt % sodium thiosulfate aqueous solution is added to the above reaction system, stirring for 2 to 10 hours at a temperature of 40 to 80° C. to complete the electroless plating process of CuS. The resulting product is filtered, washed and dried at a temperature of 105° C.

The products obtained using the process of the conductive coatings of CuS/PPy described in the present invention offers the desired electrical conductivity, thermal stability and durability with respect to the electrical conductivity, and can be useful in some technical applications such as electrostatic discharge, electromagnetic shielding, microwave absorption, etc.

The present invention will be explained in more detail with reference to Examples and Comparative Examples. However, these Examples and Comparative Examples are for illustrative purposes only and are not intended to limit the scope of the invention and claims in any way.

### Comparative Example 1

1.7 g of anhydrous ferric chloride and 100 g of deionized water were added into a flask reactor, stirring to complete dissolution. 20 g of starch was added gradually under stirring, and then 0.3 g of pyrrole monomer was added dropwise after a uniform dispersion was formed. The reaction was kept at room temperature for 2 hours. The resulting powder was filtered and washed with sufficient water until the filtrate was colorless. The product was dried in a vacuum oven at room temperature for 24 hours. It had the appearance of black powder. Its electrical conductivity was poor, giving a resistance of more than 10¹²Ω/□.

### Comparative Example 2

5 g of copper sulfate pentahydrate and 30 g of deionized water were added into a flask reactor, stirring to complete dissolution. 10 g of starch was added gradually under stirring. When a uniform dispersion was formed, the reaction was heated up to 55° C. Subsequently, 6 g of sodium thiosulfate pentahydrate was dissolved in 10 g of deionized water in a beaker, and then the solution was added to the flask reactor. The reaction temperature was kept at 55° C. under stirring for 10 hours. The resulting powder was filtered and washed with water until the filtrate was colorless. The product was dried in an air oven at 105° C. for 2 hours. Color of the resulting powder looks brown. Its electrical conductivity was poor, giving a resistance of more than 10¹²Ω/□.

### Comparative Example 3

1 g of copper sulfate pentahydrate and 20 g of deionized water were added into a flask reactor, stirring to complete dissolution. A piece of PET fabric of 1.2 g was soaked and immersed in the above solution. The flask reactor was heated up to 80° C. Subsequently, 1.1 g of sodium thiosulfate pentahydrate was dissolved in 10 g of deionized water in a beaker, and then the solution was added to the flask reactor. The reaction temperature was kept at 80° C. under shaking for 5 hours. The resulting fabric was squeezed and washed with water until the wash water was colorless. The fabric product was dried in an air oven at 150° C. for 2 hours. Color of the resulting fabric was slightly blue, but not uniform. Its electrical conductivity was poor, giving a resistance of more than 10¹²Ω/□. It is indicated that there is no CuS coating formed on the PET fabric surface.

### Example 1

Initially, the PPy-coated starch was prepared using the method same as the one for Comparative Example 1. A sample of the above PPy-coated starch was tested and showed a resistance of more than 10¹²Ω/□. Subsequently. 5 g of copper sulfate pentahydrate and 30 g of deionized water were added into a flask reactor, stirring to complete dissolution. 10 g of the above PPy-coated starch was added gradually under stirring. When a uniform dispersion was formed, the reaction was heated up to 55° C. 6 g of sodium thiosulfate pentahydrate was dissolved in 10 g of deionized water in a beaker, and then the solution was added to the flask reactor. The reaction temperature was kept at 55° C. under stirring for 8 hours. The resulting powder was filtered and washed with water until the filtrate was colorless. The product was dried in an air oven at 105° C. for 4 hours. Color of the resulting powder looks black. The resistivity of this product was measured to be about 10⁵Ω/□ that is within a range of the desired electrical conductivity for many applications.

### Example 2

6 g of anhydrous ferric chloride and 200 g of deionized water were added into a flask reactor, stirring to complete dissolution. 20 g of starch was added gradually under stirring, and then 1 g of pyrrole monomer was added dropwise after a uniform dispersion was formed. The reaction was kept at room temperature for 2 hours. The resulting powder was filtered and washed with sufficient water until the filtrate was colorless. The product was dried in a vacuum oven at room temperature for 24 hours. It had the appearance of black powder. Its electrical conductivity was poor, giving a resistance of more than 10¹²Ω/□.

### Example 3

5 g of copper sulfate pentahydrate and 30 g of deionized water were added into a flask reactor, stirring to complete dissolution. 10 g of the above PPy-coated starch was added gradually under stirring. When a uniform dispersion was formed, the reaction was heated up to 55° C. 6 g of sodium thiosulfate pentahydrate was dissolved in 10 g of deionized water in a beaker, and then the solution was added to the flask reactor. The reaction temperature was kept at 55° C. under stirring for 10 hours. The resulting powder was filtered and washed with water until the filtrate was colorless. The product was dried in an air oven at 105° C. for 4 hours. Color of the resulting powder looks black. The resistivity of this product was measured to be about 10⁴Ω/□ that is within a range of the desired electrical conductivity for many applications. Its resistivity remained at 10⁴Ω/□ after the sample was stored in air at room temperature for about 3 months.

### Example 4

6 g of anhydrous ferric chloride and 200 g of deionized water were added into a flask reactor, following with addition of 1 g of p-toluenesulfonic acid monohydrate and stirring to complete dissolution. 120 g of starch was added gradually under stirring, and then 1 g of pyrrole monomer was added dropwise after a uniform dispersion was formed. The reaction was kept at room temperature for 2 hours. The resulting powder was filtered and washed with sufficient water until the filtrate was colorless. The product was dried in a vacuum oven at room temperature for 24 hours. It had the appearance of black powder. Its electrical conductivity was poor, giving a resistance of more than 10¹²Ω/□.

### Example 5

5 g of copper sulfate pentahydrate and 30 g of deionized water were added into a flask reactor, stirring to complete dissolution. 10 g of the above PPy-coated starch was added gradually under stirring. When a uniform dispersion was formed, the reaction was heated up to 55° C. 6 g of sodium thiosulfate pentahydrate was dissolved in 10 g of deionized water in a beaker, and then the solution was added to the flask reactor. The reaction temperature was kept at 55° C. under stirring for 6 hours. The resulting powder was filtered and washed with water until the filtrate was colorless. The product was dried in an air oven at 105° C. for 4 hours. Color of the resulting powder looks black. The resistivity of this product was measured to be about 10⁴Ω/□ that is within a range of the desired electrical conductivity for many applications. Its resistivity remained at 10⁴Ω/□ after the sample was stored in air at room temperature for about 3 months.

### Example 6

1.7 g of anhydrous ferric chloride and 100 g of deionized water were added into a flask reactor, stirring to complete dissolution. A piece of PET fabric of 3.5 g was soaked and immersed in the above solution. The flask reactor was kept to 10° C. Subsequently, 0.3 g of pyrrole monomer was added dropwise to the flask reactor under shaking. The reaction temperature was kept at 10° C. under shaking for 2 hours. The resulting fabric was squeezed and washed with water until the wash water was colorless. The fabric product was dried in an air oven at 130° C. for 2 hours. Color of the resulting fabric was black. The resistivity of this fabric product was measured to be about 10⁵Ω/□. It is indicated that there is a PPy coating formed on the PET fabric surface.

### Example 7

1 g of copper sulfate pentahydrate and 20 g of deionized water were added into a flask reactor, stirring to complete dissolution. A piece of the PPy coated fabric of 1.2 g from Example 6 was soaked and immersed in the above solution. The flask reactor was heated up to 80° C. Subsequently. 1.1 g of sodium thiosulfate pentahydrate was dissolved in 10 g of deionized water in a beaker, and then the solution was added to the flask reactor. The reaction temperature was kept at 80° C. under shaking for 6 hours. The resulting fabric was squeezed and washed with water until the wash water was colorless. The fabric product was dried in an air oven at 150° C. for 2 hours. Color of the resulting fabric was dark blue. The resistivity of this fabric product was measured to be about 10⁴ Ω/□. It is indicated that there is a CuS coating formed on the fabric surface.

### Example 8

A sample of the PPy-coated fabric prepared according to Example 6 and a sample of the CuS/PPy-coated fabric prepared according to Example 7 were heated at 200° C. in an air oven to test their thermal stability with respect to the electrical conductivity. The test results were listed below:

| | Resistance (Ω/□) | Resistance (Ω/□) |
|---|---|---|
| Time (hour) | PPy-coated fabric | CuS/PPy-coated fabric |
| 0 | 10⁵ | 10⁴ |
| 2 | 10⁷ | 10⁴ |
| 4 | 10⁸ | 10⁴ |
| 6 | 10¹² | 10⁴ |

It will be understood that the specification and examples are illustrative but not limitative of the present invention and that other embodiments within the spirit and scope of the invention will suggest themselves to those skilled in the art.

The invention claimed is:

1. An electrically conductive coating comprising copper sulfide (CuS)/polypyrrole (PPy).

2. An electrically conductive coating according to claim 1 wherein said copper sulfide has the formula CuₓS (x=1˜2) and said polypyrrole was polymerized from pyrrole monomer or pyrrole derivatives.

3. An electrically conductive coating process from CuS/PPy according to claim 1 or 2.

4. An electrically conductive coating and the process according to claims 1, 2 or 3 that are applied to many non-conductive engineered materials as substrates, including organic or inorganic powders, fibers, films, foams and even bulk materials, rendering the substrates electrically conductive on their surfaces.

5. An electrically conductive coating and the process according to claims 1, 2, 3 or 4 wherein 0.01 to 20 wt % pyrrole monomer is needed to effectively encapsulate overall the substrate.

6. An electrically conductive coating and the process according to claims 1, 2, 3, 4 or 5 wherein the procedure is as follows:
(1) An oxidant, such as ferric chloride, persulfate, cerium ammonium nitrate, etc., is dissolved in water at a concentration of 0.1 to 20 wt % for later use.
(2) A substrate material to be treated, including organic or inorganic powders, fibers, films, foams and even bulk materials, is dispersed or immersed in the above oxidant aqueous solution, stirring at a temperature of 0 to 45° C.
(3) Pyrrole monomer or pyrrole solution in a solvent like alcohols is added dropwise to the above reaction system, stirring for 30 minutes to 2 hours at a temperature of 0 to 45° C. to complete the “in-situ polymerization” reaction. The resulting product is filtered and washed with sufficient water.
(4) Copper sulfate is dissolved in water at a concentration of 1 to 30 wt % for later use.
(5) The product from step 3, i.e., the PPy-coated substrate, is dispersed or immersed in the above copper sulfate aqueous solution.
(6) 1 to 20 wt % sodium thiosulfate aqueous solution is added to the above reaction system, stirring for 2 to 10 hours at a temperature of 40 to 80° C. to complete the electroless plating process of CuS. The resulting product is filtered, washed and dried at a temperature of 105° C.

7. An electrically conductive coating and the process according to claims 1, 2, 3, 4, 5 or 6 wherein the starch-based conductive powders are made from natural starch or modified starch by crosslinking, esterification, etc.

8. An electrically conductive coating and the process according to claims 1, 2, 3, 4, 5 or 6 wherein fibers and fabrics are selected as substrates from glass fibers, polyester fibers, polyamide fibers, polylactic acid fibers, polyacrylonitrile fibers, polypropylene fibers, etc.
